(19) United States
(12) Patent Application Publication
(10) Pub. No.: US 2015/0243197 A1
(43) Pub. Date: Aug. 27, 2015

(54) Multimedia Display Board

(71) Applicant: Peter Boylan, Abilene, TX (US)

(72) Inventor: Peter Boylan, Abilene, TX (US)

(21) Appl. No.: 14/630,208

(22) Filed: Feb. 24, 2015

Related U.S. Application Data
(60) Provisional application No. 61/943,563, filed on Feb. 24, 2014.

(51) Int. Cl. G09F 27/00; G09F 13/22; G09F 13/00; G09F 15/00; G09F 7/18

(52) U.S. Cl. CPC G09F 27/00; G09F 15/00; G09F 7/18; G09F 13/00; G09F 13/22; G09F 2007/1852; G09F 2027/002

(57) ABSTRACT

A multimedia display board capable of storing and displaying information is provided. The display board facilitates communication through a plurality of messaging surfaces and a digital text display. The display board also includes an audio recording and playback mechanism. The combination of display surfaces, a scrolling text display, and an audio recording and playback device allows users to easily store and access both written and verbal information.

### CROSS REFERENCE TO RELATED APPLICATION

This application claims the benefit of U.S. Provisional Application No. 61/943,563 filed on Feb. 24, 2014. The above identified patent application is herein incorporated by reference in its entirety to provide continuity of disclosure.

### FIELD OF THE INVENTION

The present invention relates to an information display device. More specifically, the invention relates to a device for storing and communicating audio and visual information.

### BACKGROUND OF THE INVENTION

Display boards such as bulletin boards and dry erase boards exist in the prior art. These devices may be used for communicating written information between users, or as a means for reminding a user of previously stored information. Such methods of communication include writing down and displaying information such as messages to others or reminders. However, these devices are limited users to communicating via hand-written messages, whether attached to the display board or written directly on the surface of the display board. Users may have the desire to communicate in more than one format using a single device. It is therefore desirable to provide a display board that allows users to display information and communicate with others through a variety of media.

In addition to communicating using written information, users may also desire to communicate via a combination of written information and audio information. An audio message may grab the user's attention from afar to remind the user of a piece of written information. An audio message may also be used to communicate information quickly between users, or may serve as an alternative to using written communication. It is desirable to provide a multimedia display board that allows users to record and playback audio and display visual information.

Another disadvantage of display boards with reusable display surfaces in the prior art is that the information is displayed in a manner that makes it susceptible to destruction. For example, information displayed on a dry erase board can be accidentally erased by someone brushing up against it. A digital text display with a memory storage may be used in order to store and display information in a more secure manner. Therefore, it is desirable to provide a multimedia display board that facilitates communication via both analog and digital information display surfaces.

### SUMMARY OF THE INVENTION

In view of the foregoing disadvantages inherent in the known types of display boards now present in the prior art, the present invention provides a multimedia display board wherein the same can be utilized for providing convenience for the user when recording and displaying information. The present system comprises a multimedia display board capable of displaying written information on a plurality of display surfaces, recording and playing back audio, and storing and displaying information on a digital display screen.

It is an object of the present invention to provide a multimedia display board consisting essentially of a substantially rectangular base having a front and rear surface, said front surface comprising a frame having raised edges, and plurality of message display surfaces disposed within said frame, said rear surface comprising a means for attaching said board to another surface, an audio recording and playback mechanism, said audio recording and playback device comprising a microphone and a speaker disposed within the at least one message display surface, and an electronic display screen.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of a multimedia display board according to the present invention.

FIG. 2 shows a rear view of a multimedia display board according to the present invention.

FIG. 3 shows a schematic of the electronic functions of a multimedia display board according to the present invention.

### DETAILED DESCRIPTION OF THE INVENTION

Reference is made herein to the attached drawings. Like reference numerals are used throughout the drawings to depict like or similar elements of the present invention. For the purposes of presenting a brief and clear description of the present invention, the preferred embodiment will be discussed as used for a multimedia display board. The figures are intended for representative purposes only and should not be considered to be limiting in any respect.

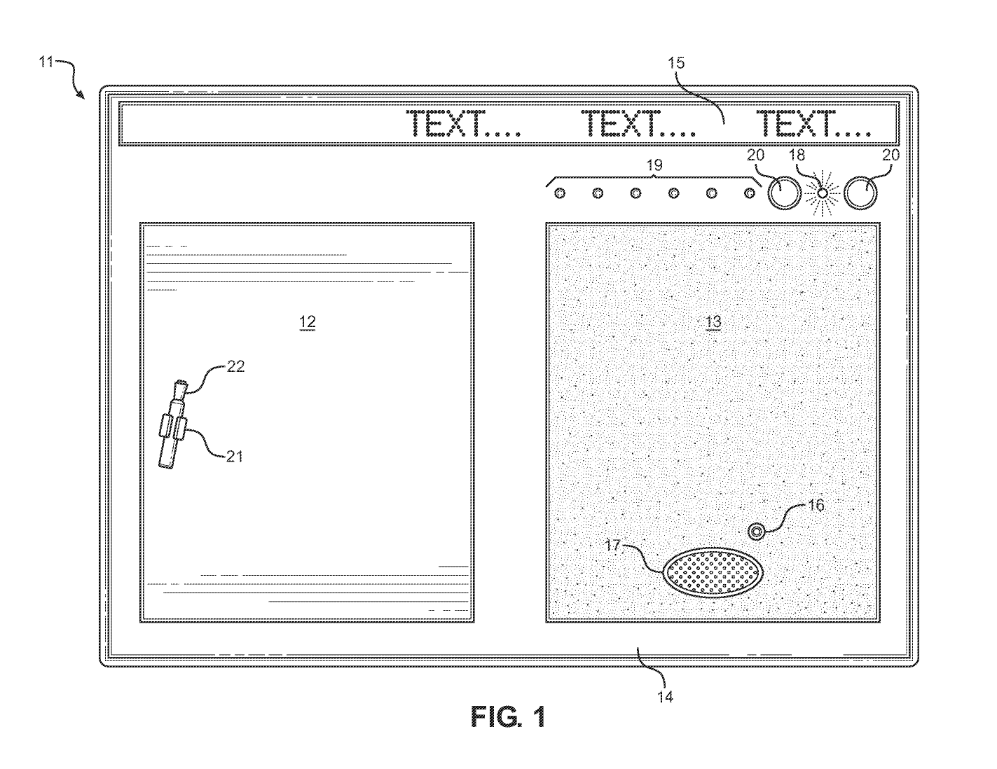

Referring now to FIG. 1, there is shown a front view of a multimedia display board 11 according to the present invention. The display board 11 includes a frame 14 having a substantially rectangular body. The display board 11 contains at least one message display surface. In a preferred embodiment of the invention, the device includes a dry erasable whiteboard surface 12 and a corkboard surface 13 disposed in the frame 14. The whiteboard surface 12 further includes a holder 21 for holding a dry erase marker 22. In one embodiment of the present invention, the holder 21 is integrally affixed to the surface of the whiteboard surface 12. In another embodiment of the present invention, the holder 21 is removably affixed to the whiteboard surface 12 via any such means known in the prior art, such as a magnetic connection. The marker 22 may be used to write information on the whiteboard surface 12. The corkboard surface 12 facilitates the attachment of paper notes, pictures, or other objects via a fastener such as a thumbtack. The frame 14 surrounds both the whiteboard surface 12 and the corkboard surface 13 such that each display surface is disposed discretely within the frame 14.

The multimedia display board 11 also includes a mechanism for recording and playing audio. A speaker 17 and a microphone 16 are disposed within the corkboard surface 13. The multimedia display board comprises control buttons 19 disposed in the frame 14 that facilitate recording via the microphone 16 and playback from the speaker 17. The speaker 17 and the microphone 16 are preferably powered by a power source, such as a battery, so that the device may be portable. The control buttons 19 are configured to control various aspects of the audio recording and playback device. The control buttons 19 may facilitate functions such as recording, playing back a recording, and deleting a recording when depressed by the user. The device may include additional buttons 20 disposed within the frame 14 that may facilitate further operation of the device.

The multimedia display board 11 includes a digital display screen 15 such as, for example, an LCD screen. In additions to facilitating the audio playback and recording functions of the multimedia display board 11, the control buttons 19 and the additional buttons 20 also may also be configured to input information that may be subsequently displayed on the digital display screen 15 when the control buttons 19 and the additional buttons 20 are depressed either one at a time or in a particular sequence. In a preferred embodiment, user-inputted information is displayed on the digital display screen 15 such that the displayed text repeatedly scrolls from the right side of the digital display screen 15 to the left side. The movement of the text allows messages that would normally be too long to fit on the digital display screen 15 to be displayed and read by a user.

The multimedia display board 11 may also include an indicator light 18 which may be used to notify the user of the various functions of the board. For example, the indicator light 18 may turn on when the user depresses a control button 19 or an additional button 20 that activates the audio recording function of the multimedia display board 11. The indicator light 18 may be utilized to perform a variety of functions, such as indicating whether the device is on or off, turning on when there is a message currently stored on the device, or turning on in response to some other function of the device that is desirable to indicate to the user.

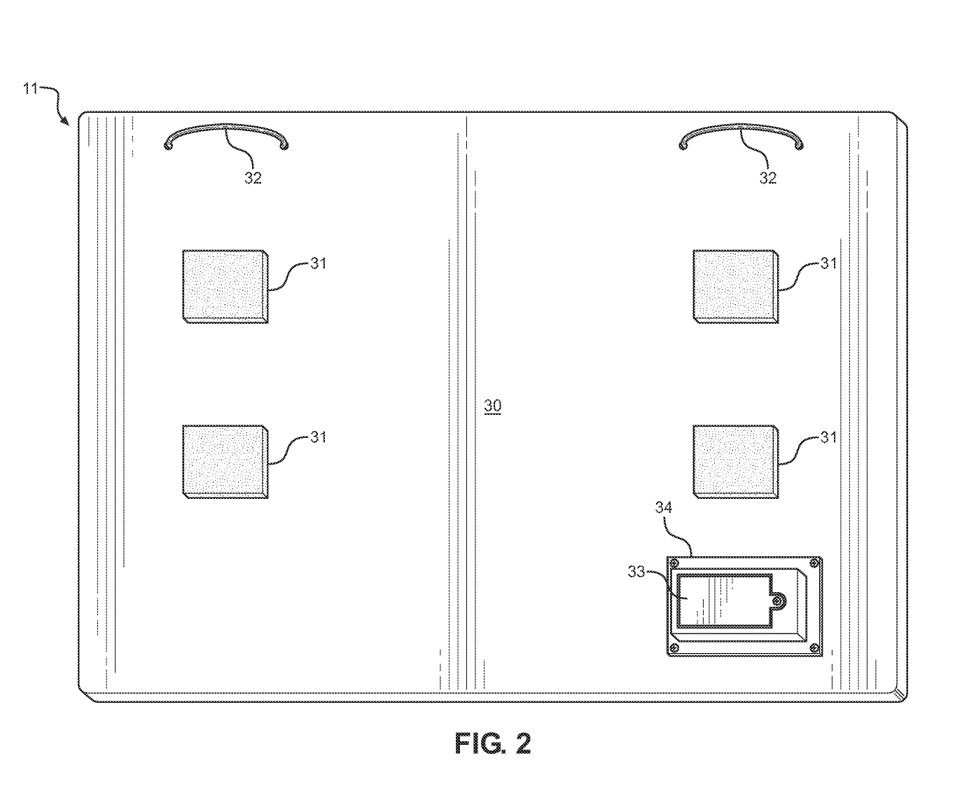

Referring now to FIG. 2, a rear view of a multimedia display board 11 according to the present invention is shown. The rear surface 30 of the multimedia display board 11 is integrally formed with the frame 14. In one embodiment of the present invention, the rear surface 30 comprises a variety of connectors to facilitate attaching the multimedia display board 11 to another surface. In the depicted embodiment of the present invention, the connectors comprise hanging hooks 32 disposed on the rear surface 30 that can be used to hang the multimedia display board 11 on a substantially vertical surface, such as an interior wall in a home, via a hanging post, such as a nail. In the depicted embodiment of the present invention, the connectors further comprise adhesive tabs 31 attached to the rear surface 30, which facilitate attaching the device to a surface without causing structural damage to the attachment surface. Although the depicted embodiment of the present invention comprises both adhesive tabs 31 and hanging hooks 32 disposed on the rear surface 30, the connectors of the present invention is not limited to two types of connectors can include one or more types of connectors. Additionally, the device may include magnets to facilitate attaching the device to a magnetic surface such as a refrigerator door.

The rear surface 30 of the multimedia display board 11 also includes the mechanism for powering the electronic components of the device. The electronic components of the multimedia display board 11 are preferably powered by a battery so that the multimedia display board 11 may be utilized in an area not near an electrical outlet. A battery compartment 34 is disposed within the rear surface 30 of the multimedia display board 11. The battery compartment 34 may also include a hinged lid 33 to hold the battery in place. Alternatively, the device may be powered via an NC adapter.

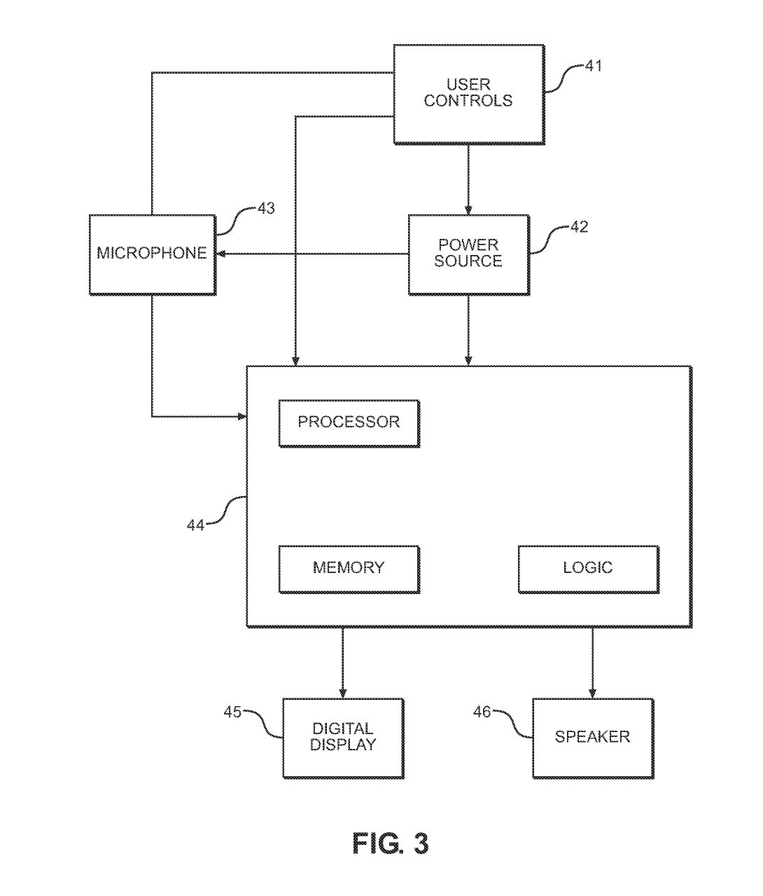

Referring now to FIG. 3, a schematic depiction of the electronic components of the device is shown. In order to operate the device, a user must first turn on the device via the user controls 41, which correspond with the control buttons 19 and the additional buttons 20. The user controls 41 are in communication with the power source 42, which is a battery located in the battery compartment 34 in the depicted embodiment of the present invention. When operational, the power source 42 sends power to a microphone 43 which is needed in order for a user to record information. The user controls 41 and the microphone 43 are in communication with a computer 44 which consists of standard components in communication with one another such as a processor, a memory storage, and a logic. As used herein, “logic” refers to (i) logic implemented as computer instructions and/or data within one or more computer processes and/or (ii) logic implemented in electronic circuitry.

The user controls 41 are used to operate the recording and storage functions of the computer 44. When prompted by the user via the user controls 41, the microphone 43 picks up sounds which are then stored in a memory storage of the computer 44. Similarly, when the user controls 41 are utilized to input a digital text message, the text information is stored within the memory storage. The computer 44 is in communication with a digital display 45 such as an LCD screen that then may either display the stored text information automatically or when prompted by a user via the user controls 41. The computer 44 is also in communication with the speaker 46 and sends stored sound information to a speaker 46 when prompted by a user via the user controls 41.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An information display device comprising:
a front and rear surface, the front surface comprising a frame having raised edges, and a plurality of message display surfaces disposed within the frame;
the rear surface comprising a connector;
an audio recording and playback mechanism, the audio recording and playback device comprising a microphone and a speaker disposed within the at least one message display surface;
an electronic display screen.

2. The device of claim 1, wherein the audio recording and playback mechanism and the electronic display are powered by a battery.

3. The device of claim 1, wherein the plurality of display surfaces comprise a cork board surface and an erasable whiteboard surface.

4. The device of claim 1, wherein the means for attaching the rear surface of the board to another surface comprise adhesive tabs, hooks, and magnets.

5. The device of claim 1, wherein the rear surface further comprises a battery compartment disposed within the rear surface.

6. The device of claim 1, further comprising a plurality of buttons disposed along the frame configured to operate the audio recording and playback mechanism and the electronic display screen.

7. The device of claim 1, further comprising an indicator light disposed within the frame.

8. The device of claim 1, wherein the electronic display comprises an LCD display.

9. The device of claim 1, wherein the message display surfaces are discrete and separated by the frame.
